(19) United States
(12) Patent Application Publication
(10) Pub. No.: US 2014/0068891 A1
(43) Pub. Date: Mar. 13, 2014

(54) POWER FACTOR CORRECTION CIRCUIT, POWER SUPPLY DEVICE AND VACUUM CLEANER USING THE SAME

(71) Applicant: SUMSUNG ELECTRO-MECHANICS CO., LTD., Suwon (KR)

(72) Inventors: Hyung Joon Kim, Suwon (KR); Han Kyung Bae, Suwon (KR); Hong Chul Shin, Suwon (KR)

(73) Assignee: SUMSUNG ELECTRO-MECHANICS CO., LTD., Suwon (KR)

(21) Appl. No.: 13/770,502

(22) Filed: Feb. 19, 2013

(30) Foreign Application Priority Data
Sep. 11, 2012 (KR) 10-2012-0100676

(51) Int. Cl. H02M 5/44

(52) U.S. Cl. CPC H02M 5/44
USPC 15/412; 307/154

(57) ABSTRACT

A power factor correction circuit, a power supply device and a vacuum cleaner using the same. The power supply device for a vacuum cleaner is applicable to a vacuum cleaner having a flexible hose. The power supply device for a vacuum cleaner includes: A power factor correction unit correcting a power factor of an AC voltage supplied from an AC power source; a rectifying unit rectifying the AC voltage power factor-corrected by the power factor correction unit into a direct current (DC) voltage and outputting the DC voltage; a smoothing unit smoothing the DC voltage output from the rectifying unit and outputting the smoothed the DC voltage; an a converting unit converting the smoothed DC voltage from the smoothing unit into an AC voltage, wherein the power factor correction unit uses a conductive line included in the flexible hose, as an inductor.

### CROSS-REFERENCE TO RELATED APPLICATIONS

This application claims the priority of Korean Patent Application No. 10-2012-0100676 filed on Sep. 11, 2012, in the Korean Intellectual Property Office, the disclosure of which is incorporated herein by reference.

### BACKGROUND OF THE INVENTION

1. Field of the Invention

The present invention relates to a power factor correction circuit having a small size and requiring reduced unit costs by using a flexible hose of a vacuum cleaner as an inductor, a power supply device and a vacuum cleaner using the same.

2. Description of the Related Art

As electronic products have been reduced in size, there has been demand for reductions in the size of home appliances, including vacuum cleaners.

Recently, home appliances have required the inclusion of circuits for power factor correction and EMI/EMC protection.

However, the related art circuits for power factor correction and EMI/EMC protection need to include an inductor, such that the size of circuits, and home appliances in which they are included, have increased due to the volume of the inductors, and costs thereof have also increased.

The patent document mentioned below relates to a power supply device including a power factor correction circuit, but does not disclose matters related to a reduction in a size of an inductor and satisfying demands for cost reductions.

### RELATED ART DOCUMENT

(Patent Document 1) Korean Patent Laid Open Publication No. 10-2011-0010232

### SUMMARY OF THE INVENTION

An aspect of the present invention provides a power factor correction circuit including an inductor configured by using a hose of a vacuum cleaner, thus allowing for a product having a reduced size and incurring low costs, and a power supply device for a vacuum cleaner using the same.

According to an aspect of the present invention, there is provided a power supply device for a vacuum cleaner having a flexible hose, the power supply device including: a power factor correction unit correcting a power factor of an AC voltage supplied from an AC power source; a rectifying unit rectifying the AC voltage power factor-corrected by the power factor correction unit into a direct current (DC) voltage and outputting the DC voltage; a smoothing unit smoothing the DC voltage output from the rectifying unit and outputting the smoothed the DC voltage; and a converting unit converting the smoothed DC voltage from the smoothing unit into an AC voltage, wherein the power factor correction unit uses a conductive line included in the flexible hose, as an inductor.

The flexible hose may include a helically wound conductive line, and the power factor correction unit may be electrically connected to both ends of the conductive line and use the conductive line as an inductor.

The flexible hose may include a connector at a connection terminal of the vacuum cleaner, the connector having a pair of terminals respectively connected to the both ends of the conductive line.

The conductive line may have one end electrically connected to one terminal of the pair of terminals of the connector and the other end extending along an interior of the flexible hose and electrically connected to the other terminal of the pair of terminals.

The power factor correction unit may be electrically connected to the pair of terminals of the connector and use the conductive line electrically connected thereto through the connector, as an inductor.

The flexible hose may further include an inner pipe provided inwardly of the conductive line.

The inner pipe may be made of magnetic synthetic plastic.

The power factor correction unit may include first and second capacitor units connected to a pair of input terminals and a pair of output terminals in parallel, respectively; and an inductor unit connected to the respective first and second capacitors in parallel and configured as the helically wound conductive line.

According to another aspect of the present invention, there is provided a vacuum cleaner. The vacuum cleaner includes a suction unit; a flexible hose having one end coupled to the suction unit; and a vacuum cleaner main body generating vacuum suction force by using power generated by a power supply device, and coupled to the other end of the flexible hose to provide the vacuum suction force to the suction unit, wherein the power supply device includes a power factor correction unit a power factor of an AC voltage supplied from an AC power source, and the power factor correction unit uses a conductive line included in the flexible hose, as an inductor.

The flexible hose may include a helically wound conductive line, and the power supply device may include a power factor correction unit correcting the power factor of the AC voltage and electrically connected to both ends of the conductive line to use the conductive line as an inductor; a rectifying unit rectifying the AC voltage power factor-corrected by the power factor correction unit into a direct current (DC) voltage and outputting the DC voltage; a smoothing unit smoothing the DC voltage output from the rectifying unit and outputting the smoothed the DC voltage; and a converting unit converting the smoothed DC voltage from the smoothing unit into an AC voltage.

The flexible hose may further include an inner pipe provided inwardly of the conductive line and made of magnetic synthetic plastic.

According to another aspect of the present invention, there is provided power factor correction circuit for a vacuum cleaner having a flexible hose, the power factor correction circuit comprising: a first capacitor unit connected to a pair of input terminals connected to an AC power source in parallel; a second capacitor unit connected to a pair of output terminals in parallel; and an inductor unit connected to the respective first and second capacitors in parallel, wherein the inductor unit uses a helically wound conductive line included in the flexible hose.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an example of a vacuum cleaner;

FIG. 2 is a view illustrating a configuration of an example of a power supply device;

FIG. 3 is a perspective view of a vacuum cleaner according to an embodiment of the present invention;

FIG. 4 is a view illustrating a configuration of a power supply device applicable to the vacuum cleaner of FIG. 3;

FIG. 5 is a perspective view illustrating an example of a conductive line of a flexible hose for a vacuum cleaner according to an embodiment of the present invention;

FIG. 6 is a perspective view illustrating another example of a conductive line of a flexible hose for a vacuum cleaner according to an embodiment of the present invention;

FIG. 7 is a cross-sectional view partially illustrating an example of a flexible hose for a vacuum cleaner according to an embodiment of the present invention; and

FIG. 8 is a perspective view partially illustrating the flexible hose of FIG. 7.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

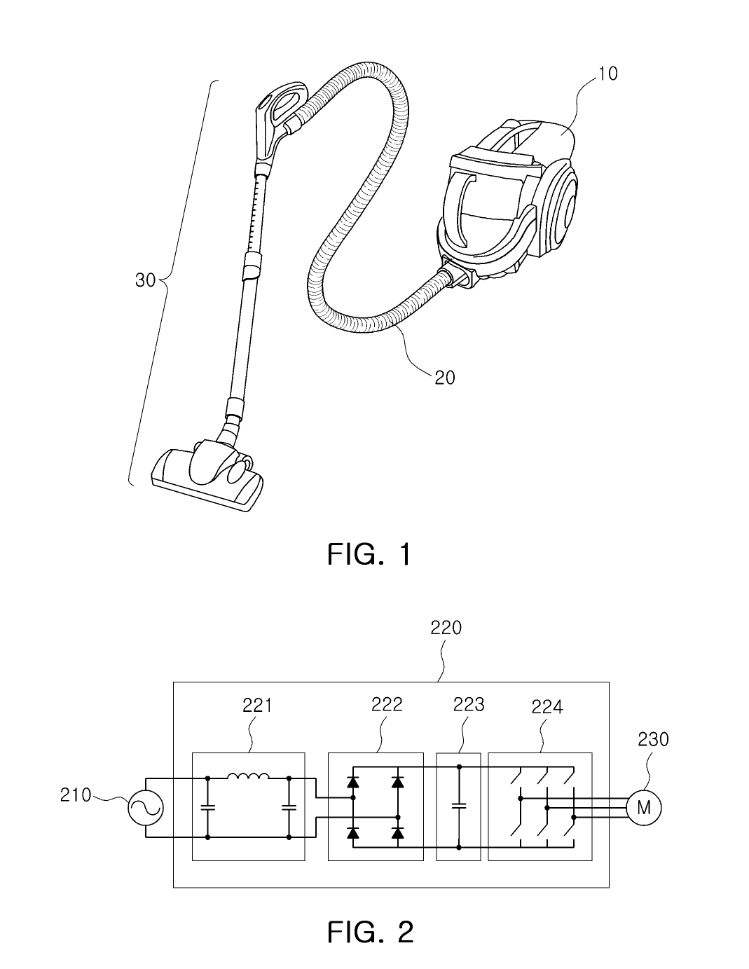

FIG. 1 is a perspective view illustrating an example of a vacuum cleaner.

Referring to FIG. 1, the vacuum cleaner may include a main body 10, a flexible hose 20, and a suction unit 30.

The main body 10 generates vacuum suction force to draw foreign objects through the suction unit 30 and the flexible hose 20.

In detail, the main body 10 may include a power supply device and a motor, and may rotate a motor by using power supplied from the power supply device to generate vacuum suction force. The main body 10 may include a filter therein to store the drawn foreign objects.

The flexible hose 20 may move flexibly. The flexible hose 20 is a means for providing the foreign objects drawn through the suction unit 30 to the main body 10, and as illustrated, the flexible hose 20 may be in the form of a flexibly extending pipe.

In order to secure flexibility, the flexible hose 20 may be realized in a helical shape or in the form of a pipe having circular joints.

The suction unit 30 may draw external foreign objects by using vacuum suction force generated by the main body 10. The suction unit 30 may include be variously configured according to embodiments. As illustrated, the suction unit 30 may include a handle part, an extending pipe part, a ground contact part, and the like.

FIG. 2 is a view illustrating a configuration of an example of a power supply device.

Referring to FIG. 2, a power supply device 220 may rectify and smooth a voltage supplied from an alternating current (AC) power source 210, to provide the rectified and smoothed voltage to a motor 230.

The power supply device 220 may include a power factor correction unit 221, a rectifying unit 222, a smoothing unit 223, and a converting unit 224.

The power factor correction unit 221 may correct a power factor of an AC voltage supplied from the AC power source 210.

The power factor correction unit 221, a circuit for correcting a power factor of the AC voltage, may include an inductor as an element. However, the inductor requires a conductive wire wound by a preset number of times or more, such that there are limitations in that the volume of the inductor itself is increased. Therefore, the size of the power supply device 220 inevitably increases and costs required therefor increase.

The rectifying unit 222 may rectify the AC voltage power factor-corrected by the power factor correction unit 221 into a direct current (DC) voltage and output the DC Voltage.

The smoothing unit 223 may smooth the DC Voltage output from the rectifying unit 222 and output the smoothed DC Voltage.

The converting unit 224 may convert the smoothed DC Voltage output from the smoothing unit 223 into a further AC voltage.

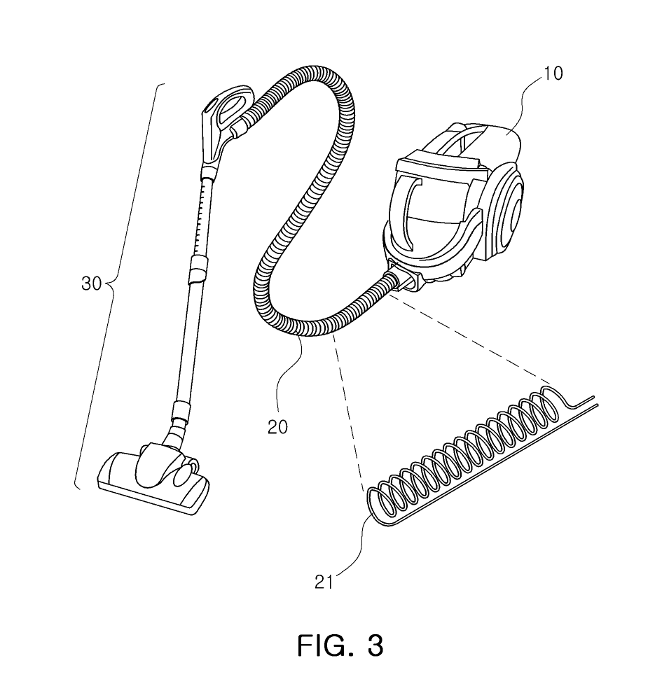

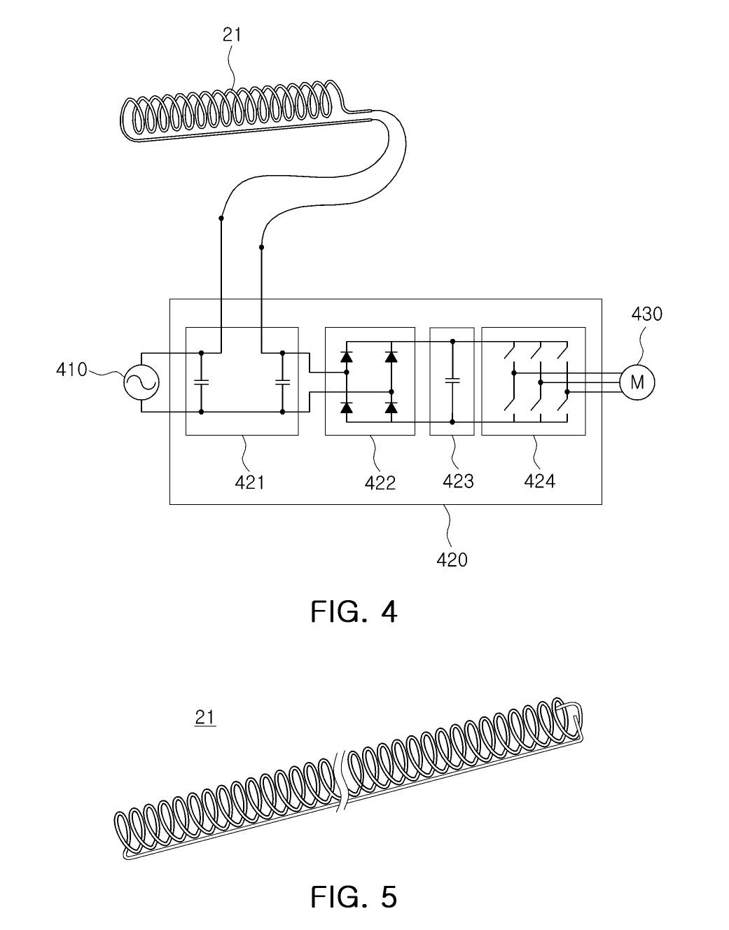

FIG. 3 is a perspective view of a vacuum cleaner according to an embodiment of the present invention, and FIG. 4 is a view illustrating a configuration of a power supply device applicable to the vacuum cleaner of FIG. 3.

In the vacuum cleaner according to the embodiment, to be described hereinafter with reference to FIGS. 3 and 4, a predetermined conductor 21 is included in the flexible hose 20, and a power supply device 420 uses the conductor 21 as an inductor.

In the embodiment of the vacuum cleaner to be described hereinafter, descriptions thereof corresponding to or the same as the above description with reference to FIGS. 1 and 2 will not be described.

Referring to FIG. 3, the vacuum cleaner may include the main body 10, the flexible hose 20, and the suction unit 30.

The flexible hose 20 may move flexibly. The flexible hose 20 is a means for providing foreign objects drawn through the suction unit 30 to the main body 10, and as illustrated, the flexible hose 20 may be configured in the form of a flexibly extending pipe.

The flexible hose 20 may include a conductive line 21.

In order to secure flexibility, the flexible hose 20 may be realized in a helical shape or in the form of a pipe having circular joints. In an embodiment, the conductive line 21 may serve to provide flexibility to the flexible hose 20. For example, the conductive line 21 may be a conductive metal line helically wound at predetermined intervals, and the flexible hose 20 may be configured by adding an outer cover or an inter cover to the conductive line 21.

The conductive line 21 may be configured as a conductive wire.

Both ends of the conductive line 21 may be electrically connected to the power supply device 420 and operate as an inductor element.

In an embodiment, the conductive line 21 may be a helically wound conductive line.

According to an embodiment, the conductive line 21 may be helically wound to have the same diameter. In addition, the conductive line 21 may be wound such that at least one portion thereof has a different diameter from those of the remaining portion thereof. When the conductive line 21 is wound to have different diameters, the conductive line 21 may be wound according to a change in diameter of the flexible hose 20. For example, when at least one portion of the flexible hose 20 has a reduced diameter, a portion of the conductive line 21, corresponding to the at least one portion of the flexible hose 20 may also have a reduced diameter.

In an embodiment, the conductive line 21 may be included in at least one portion of the flexible hose 20. For example, the conductive line 21 may be included in the entirety of the flexible hose 20. Alternatively, the conductive line 21 may only be included in a portion (e.g., only in a portion connected to the main body 10) of the flexible hose 20.

Various embodiments of the conductive line 21 and the flexible hose 20 will be described in detail with reference to FIGS. 5 through 8.

FIG. 4 is a view illustrating a configuration of the power supply device 420 included in the main body 10.

Referring to FIG. 4, the power supply device 420 may rectify and smooth a voltage supplied from an AC power source 410, and provide the rectified and smoothed voltage to a motor 430. In the embodiment, the power supply device 420 may use the conductive line 21 as an inductor element.

The power supply device 420 may include a power factor correction unit 421, a rectifying unit 422, a smoothing unit 423, and a converting unit 424.

The power factor correction unit 421 may correct a power factor of an AC voltage supplied from the AC power source 410, and may use an inductor as an element. As illustrated in FIG. 4, the power factor correction unit 421 may use the conductive line 21 as an inductor element. Namely, the power factor correction unit 421 may be electrically connected to both ends of the conductive line 21 and use the conductive line as an inductor.

In an embodiment of the present invention, the power factor correction unit 421 may include a first capacitor unit, a second capacitor unit, and an inductor unit. The first capacitor unit may be connected to a pair of input terminals connected to the AC power source 410 in parallel. The second capacitor unit may be connected to a pair of output terminals of the power factor correction unit 421 in parallel. The inductor unit may be connected to the respective first and second capacitors in parallel, and may be configured as the helically wound conductive line 21.

The rectifying unit 422 may rectify the AC voltage power factor-corrected by the power factor correction unit 421 into a direct current (DC) voltage and output the DC Voltage.

The smoothing unit 423 may smooth the DC Voltage output from the rectifying unit 422 and output the smoothed DC Voltage.

The converting unit 424 may convert the smoothed DC Voltage output from the smoothing unit 423 into a further AC voltage and output the AC voltage. The converting unit 424 may output a 3-phase AC voltage to control driving of the motor 430.

In FIG. 4, the circuit configuration of the respective power factor correction unit 421, the rectifying unit 422, the smoothing unit 423, and the converting unit 424 is illustrated, but it is merely illustrative. Thus, in addition to the circuit configuration illustrated in FIG. 4, it may be obvious that the power supply device 420 according to the embodiment of the present invention and the power factor correction unit 421, the rectifying unit 422, the smoothing unit 423, and the converting unit 424 included in the power supply device 420 may be variously modified to be applied.

FIG. 5 is a perspective view of an example of the conductive line 21 of the flexible hose 20 for a vacuum cleaner according to an embodiment of the present invention.

Referring to FIG. 5, the conductive line 21 may be a conductive line helically wound at predetermined intervals. As mentioned above, the conductive line 21 may constitute the flexible hose 20 and serve as an inductor element of the power supply device 420.

In an embodiment of the present invention, the conductive line 21 may have a predetermined elastic force. For example, the conductive line 21 may include an elastic core made of a metal having elastic force and a conductive metal layer covering the exterior of the elastic core. Here, the metal layer may include a single layer or a plurality of layers. In another example, the conductive line 21 may be made of a metal having elastic force and conductivity.

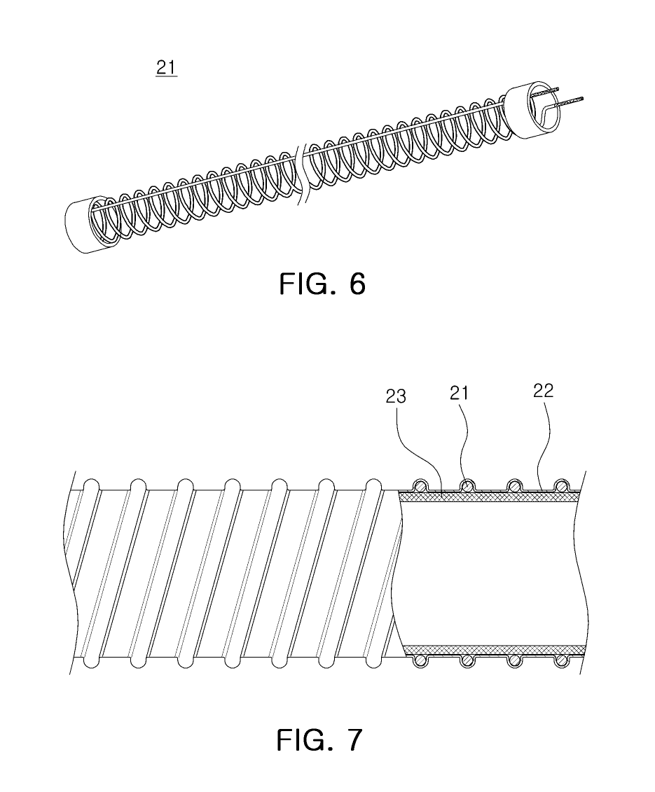

FIG. 6 is a perspective view of another example of a conductive line of a flexible hose for a vacuum cleaner according to an embodiment of the present invention.

The conductive line 21 of FIG. 6 may further include a connector. The connector may be formed on one of both ends of the conductive line 21. The connector may have a pair of terminals electrically connected to both terminals of the conductive line 21.

One end of the conductive line 21 may be electrically connected to one terminal of the pair of terminals of the connector, and the other end of the conductive line 21 may extend along the interior of the flexible hose 20 and electrically connected to the other terminal of the pair of terminals of the connector.

The flexible hose 20 may be electrically connected to the vacuum cleaner by using the pair of terminals of the connector. For example, the flexible hose 20 may have the pair of terminals of the connector at one end thereof adjacent to the main body 10 of the vacuum cleaner (namely, the pair of terminals of the connector are electrically connected to both respective ends of the conductive line 21), and the connector may electrically contact a connection terminal of the main body 10 of the cleaner. Here, since the connection terminal of the main body 10 of the cleaner may be electrically connected to the power supply device 420, the conductive line 21 may be electrically connected to the power supply device 420 through the connector.

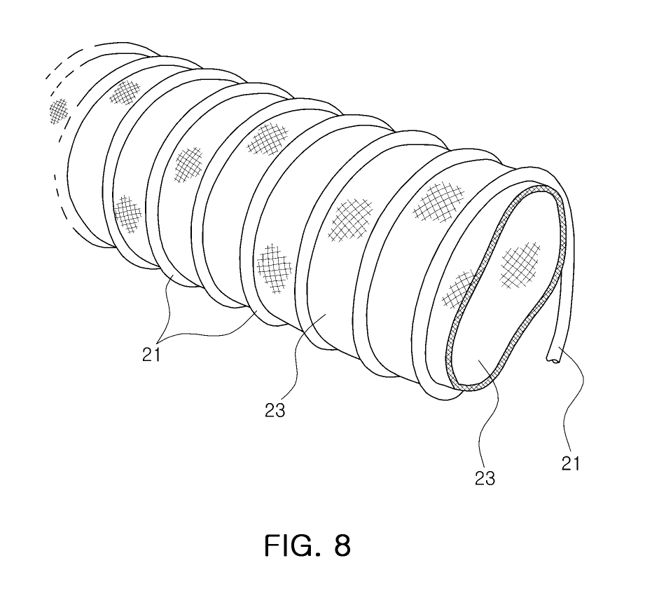

FIG. 7 is a cross-sectional view partially illustrating an example of a flexible hose for a vacuum cleaner according to an embodiment of the present invention; and FIG. 8 is a perspective view partially illustrating the flexible hose of FIG. 7.

In the embodiment of FIG. 7, the flexible hose 20 may include the conductive line 21, an outer pipe 22, and an inner pipe 23.

The outer pipe 22 may be formed on an outer side of the conductive line 21. Namely, the outer pipe 22 may form an outer cover of the flexible hose 20. The outer pipe 22 may be made of a synthetic resin capable of providing flexibility.

The inner pipe 23 may be provided inwardly of the conductive line 21. The inner pipe 23 may serve not to allow an uneven portion (i.e., a depression or protrusion) to be formed on an inner surface of the flexible hose 20, thus preventing foreign objects drawn into the cleaner from being caught in the flexible hoses 20.

In an embodiment of the present invention, as illustrated in FIG. 8, the inner pipe 23 may come into contact with an inner surface of the conductive line 21.

In an embodiment of the present invention, the outer pipe 22 or the inner pipe 23 may be made of a material having conductivity. For example, the outer pipe 22 or the inner pipe 23 may be made of magnetic synthetic plastic. In this case, since a certain magnetic field may be formed when the conductive line 21 operates as an inductor, when the outer pipe 22 or the inner pipe 23 is made of a material that does not shield such magnetic properties, the magnetic field may not attenuated, thus enhancing the characteristics of the conductive line 21 as an inductor.

As set forth above, according to embodiments of the invention, since an inductor is configured by using a flexible hose of a vacuum cleaner, the size of a power factor correction circuit and a power supply device of a vacuum cleaner can be reduced and unit costs required therefor can be reduced.

While the present invention has been shown and described in connection with the embodiments, it will be apparent to those skilled in the art that modifications and variations can be made without departing from the spirit and scope of the invention as defined by the appended claims.

What is claimed is:

1. A power supply device for a vacuum cleaner having a flexible hose, the power supply device comprising:
a power factor correction unit correcting a power factor of an AC voltage supplied from an AC power source;
a rectifying unit rectifying the AC voltage power factor-corrected by the power factor correction unit into a direct current (DC) voltage and outputting the DC voltage;
a smoothing unit smoothing the DC voltage output from the rectifying unit and outputting the smoothed the DC voltage; and
a converting unit converting the smoothed DC voltage from the smoothing unit into an AC voltage,
wherein the power factor correction unit uses a conductive line included in the flexible hose, as an inductor.

2. The power supply device of claim 1, wherein the flexible hose includes a helically wound conductive line, and
the power factor correction unit is electrically connected to both ends of the conductive line and uses the conductive line as an inductor.

3. The power supply device of claim 2, wherein the flexible hose includes a connector at a connection terminal of the vacuum cleaner, the connector having a pair of terminals respectively connected to the both ends of the conductive line.

4. The power supply device of claim 3, wherein the conductive line has one end electrically connected to one terminal of the pair of terminals of the connector and the other end extending along an interior of the flexible hose and electrically connected to the other terminal of the pair of terminals.

5. The power supply device of claim 3, wherein the power factor correction unit is electrically connected to the pair of terminals of the connector and uses the conductive line electrically connected thereto through the connector, as an inductor.

6. The power supply device of claim 2, wherein the flexible hose further includes an inner pipe provided inwardly of the conductive line.

7. The power supply device of claim 6, wherein the inner pipe is made of magnetic synthetic plastic.

8. The power supply device of claim 2, wherein the power factor correction unit includes:
first and second capacitor units connected to a pair of input terminals and a pair of output terminals in parallel, respectively; and an inductor unit connected to the respective first and second capacitors in parallel and configured as the helically wound conductive line.

9. A vacuum cleaner comprising:
a suction unit;
a flexible hose having one end coupled to the suction unit; and
a vacuum cleaner main body generating vacuum suction force by using power generated by a power supply device, and coupled to the other end of the flexible hose to provide the vacuum suction force to the suction unit,
wherein the power supply device includes a power factor correction unit a power factor of an AC voltage supplied from an AC power source, and the power factor correction unit uses a conductive line included in the flexible hose, as an inductor.

10. The vacuum cleaner of claim 9, wherein the flexible hose includes a helically wound conductive line, and
the power supply device includes:
a power factor correction unit correcting the power factor of the AC voltage and electrically connected to both ends of the conductive line to use the conductive line as an inductor;
a rectifying unit rectifying the AC voltage power factor-corrected by the power factor correction unit into a direct current (DC) voltage and outputting the DC voltage;
a smoothing unit smoothing the DC voltage output from the rectifying unit and outputting the smoothed the DC voltage; and
a converting unit converting the smoothed DC voltage from the smoothing unit into an AC voltage.

11. The vacuum cleaner of claim 10, wherein the flexible hose further includes an inner pipe provided inwardly of the conductive line and made of magnetic synthetic plastic.

12. A power factor correction circuit for a vacuum cleaner having a flexible hose, the power factor correction circuit comprising:
a first capacitor unit connected to a pair of input terminals connected to an AC power source in parallel;
a second capacitor unit connected to a pair of output terminals in parallel; and
an inductor unit connected to the respective first and second capacitors in parallel,
wherein the inductor unit uses a helically wound conductive line included in the flexible hose.
